(19) United States
(12) Patent Application Publication
(10) Pub. No.: US 2026/0115668 A1
(43) Pub. Date: Apr. 30, 2026

(54) PREPARATION METHOD FOR TUBULAR GAS-PERMEABLE MEMBRANE AND WASTEWATER TREATMENT OF AMMONIA NITROGEN REMOVAL PROCESS

(71) Applicant: CHINA HAISUM ENGINEERING CO., LTD., Shanghai (CN)

(72) Inventors: Lei HE, Shanghai (CN); Qing GOU, Shanghai (CN); Wangping ZHU, Shanghai (CN); Zhiqun SHI, Shanghai (CN); Tingting TANG, Shanghai (CN)

(73) Assignee: CHINA HAISUM ENGINEERING CO., LTD., Shanghai (CN)

(21) Appl. No.: 19/393,659

(22) Filed: Nov. 19, 2025

Related U.S. Application Data
(63) Continuation of application No. PCT/CN2024/130830, filed on Nov. 8, 2024.

(30) Foreign Application Priority Data
Oct. 30, 2024 (CN) 202411527547.7

(51) Int. Cl. B01D 69/04; B01D 69/10; B01D 71/10; B01D 71/26; B01D 71/36; C02F 1/44; C02F 101/16

(52) U.S. Cl. CPC B01D 69/043; B01D 69/1071; B01D 71/10; B01D 71/262; B01D 71/36; C02F 1/447; B01D 2325/02833; B01D 2325/02834; B01D 2325/04; C02F 2101/16

(57) ABSTRACT

A preparation method for a tubular gas-permeable membrane and a wastewater treatment of an ammonia nitrogen removal process are provided. The preparation method for a tubular gas-permeable membrane includes: cutting a flat sheet gas-permeable membrane into a strip shape, and then sequentially winding, overlapping, bonding, tubulating, and cutting the strip-shaped flat sheet gas-permeable membrane to form a tube-shaped tubular gas-permeable membrane. The preparation method is based on an original flat sheet gas-permeable membrane and an optimized rolling technology. Compared with a traditional gas-permeable membrane, the prepared tubular gas-permeable membrane has higher ammonia mass transfer efficiency, and the tubular gas-permeable membrane adopts a closed columnar membrane structure, such that an ammonia gas leakage rate can be obviously reduced, and ammonia nitrogen removal efficiency of wastewater can be greatly improved. An ammonia nitrogen resource can be recovered while ammonia nitrogen wastewater is treated, and desirable economic benefits and environmental benefits are achieved.

### CROSS REFERENCE TO THE RELATED APPLICATIONS

This application is a continuation application of International Application No. PCT/CN2024/130830, filed on Nov. 8, 2024, which is based upon and claims priority to Chinese Patent Application No. 202411527547.7, filed on Oct. 30, 2024, the entire contents of which are incorporated herein by reference.

### TECHNICAL FIELD

The present disclosure relates to a preparation method for a tubular gas-permeable membrane and a wastewater treatment of an ammonia nitrogen removal process, which belongs to the technical field of wastewater ammonia nitrogen removal treatment.

### BACKGROUND

Physical ammonia nitrogen removal technologies such as an ammonia stripping (steam stripping) method, a struvite method, and a gas-permeable membrane process have been applied to recovery of ammonia nitrogen resources from wastewater with abundant application cases. The NH₃—N can be separated and extracted from the wastewater and converted into usable ammonium salt resources, and the NH₃—N content in the wastewater can be reduced, and the carbon nitrogen (C/N) ratio can be further adjusted to facilitate subsequent biological treatment. The ammonia stripping (steam stripping) method is effective in removal of NH₃—N from the wastewater, but is high in the vapor-liquid ratio and energy consumption. In addition, scaling on the inner wall of an ammonia stripping tower or steam stripping tower is more serious. The struvite method has a simple and rapid reaction process and a desirable ammonia nitrogen removal effect, and produces high economic values from struvite by-products. However, in a case of wastewater without a phosphorus or magnesium element, the struvite method is costly due to addition of a large quantity of magnesium salt and phosphate.

The gas-permeable membrane (GPM) process uses a microporous hydrophobic membrane to separate an ammonia nitrogen-containing feed solution from an acid absorption solution and store them on two sides of the membrane. The pH of the feed solution is increased, the ionic NH₄⁺ is converted into free gaseous NH₃. Under the action of mass transfer driving force (mainly the partial pressure difference of NH₃ on the two sides of the membrane), NH₃ is absorbed by the absorption solution after passing through the microporous membrane, and has an acid-base neutralization reaction to form ammonium salt. Compared with the ammonia stripping (steam stripping) method, the gas-permeable membrane process requires neither plenty of air or water vapor to strip NH₃, nor large-size stripping tower and absorption tower apparatuses. As a result, the ammonia nitrogen removal cost is lower.

According to the form or the arrangement method of membranes, current common gas-permeable membrane modules mainly include a tubular membrane module, a hollow fiber membrane module, and a flat sheet membrane module. One or more modules can be fitted into an integrated membrane device available for factories and laboratories. The patent “Flat Sheet gas-permeable membrane for Wastewater Treatment and Preparation Method Therefor” (ZL202010862209.4) applied for by the applicant early and authorized developed a flat sheet gas-permeable membrane. The gas-permeable membrane solves the technical problem that a gas-permeable membrane module is likely to suffer contamination and blockage, but the existing gas-permeable membranes and membrane modules still have low ammonia nitrogen removal efficiency and ammonia gas leakage.

### SUMMARY

An objective of the present disclosure is to improve ammonia nitrogen removal efficiency of the traditional gas-permeable membrane and module, and solve the technical problems such as ammonia gas leakage. The present disclosure provides a preparation method for a tubular gas-permeable membrane and a wastewater treatment of an ammonia nitrogen removal process. Compared with a traditional gas-permeable membrane, the tubular gas-permeable membrane prepared by the preparation method of the present disclosure has higher ammonia mass transfer efficiency, and the tubular gas-permeable membrane adopts a closed columnar membrane structure, such that an ammonia gas leakage rate can be obviously reduced, and ammonia nitrogen removal efficiency of wastewater can be greatly improved.

In order to solve the technical problem described above, the present disclosure adopts the following technical solution:

In a first aspect of the present disclosure, a preparation method for a tubular gas-permeable membrane is provided. The preparation method includes: cutting a flat sheet gas-permeable membrane into a strip shape, and then sequentially winding, overlapping, bonding, tubulating, and cutting the strip-shaped flat sheet gas-permeable membrane to form a tube-shaped tubular gas-permeable membrane.

The flat sheet gas-permeable membrane includes a non-woven fabric substrate layer and a gas permeable layer that are bonded into a whole, the non-woven fabric substrate includes 60 wt %-90 wt % polypropylene fiber, 5 wt %-30 wt % cellulose fiber, and 5 wt %-15 wt % carbon fiber, and the gas permeable layer is an expanded polytetrafluoroethylene film.

Preferably, the flat sheet gas-permeable membrane has a quantitative range of 50 g/m²-100 g/m², a thickness of 100 μm-250 μm, an air permeability of 0.05 m/s-1.5 m/s, an average pore diameter of 0.05 μm-4.5 μm, and a contact angle of 110°-140°.

Preferably, the cut strip-shaped flat sheet gas-permeable membrane has a width of 10 mm-20 mm.

Preferably, a winding diameter of the strip-shaped flat sheet gas-permeable membrane is 5 mm-10 mm, opposite sides of the gas-permeable membrane are overlapped during winding, and a width of an overlapped area is set as 0.5 mm-2 mm.

Preferably, the bonding adopts an ultrasonic-assisted heating curing bonding process, and specifically includes: uniformly applying a chemical adhesive to an overlapped area of opposite sides of the membrane during the winding, and then performing ultrasonic-assisted heating curing, where the chemical adhesive is an aqueous dispersion liquid of acrylonitrile multipolymer, a frequency of ultrasound is 15 kHz-40 kHz, and a temperature of the heating curing is 150° C.-250° C.

Preferably, the tubulating includes: cooling a tube-shaped membrane formed through the bonding, a temperature of the cooling is 5° C.-20° C., and an inner diameter of the tube-shaped membrane is 5 mm-10 mm.

In a second aspect of the present disclosure, a tubular gas-permeable membrane prepared by the preparation method in the first aspect of the present disclosure is provided.

In a third aspect of the present disclosure, an application of the tubular gas-permeable membrane in the second aspect of the present disclosure to preparation of a tubular gas-permeable membrane module and wastewater ammonia nitrogen removal treatment is provided.

In a fourth aspect of the present disclosure, a tubular gas-permeable membrane module is provided. The tubular gas-permeable membrane module includes the tubular gas-permeable membrane in the second aspect of the present disclosure.

Preferably, a preparation method of the tubular gas-permeable membrane module includes: cutting the tubular gas-permeable membrane according to an appropriate length and size and a required filling number, then filling an encapsulation tube with cut membranes sequentially, performing adhesive filling and curing, and making the tubular gas-permeable membrane module.

In a fifth aspect of the present disclosure, an application of the tubular gas-permeable membrane module in the fourth aspect of the present disclosure to wastewater ammonia nitrogen removal treatment is provided.

In a sixth aspect of the present disclosure, a method adopting the tubular gas-permeable membrane module for wastewater ammonia nitrogen removal treatment in the fourth aspect of the present disclosure is provided. The method includes:
step 1): adjusting a pH of ammonia nitrogen wastewater to alkalinity;
step 2): adjusting a temperature of the ammonia nitrogen wastewater, then pumping the ammonia nitrogen wastewater into a tube side of the tubular gas-permeable membrane module, and adjusting a membrane surface flow rate;
step 3): pumping an acid absorption solution into a shell side of the tubular gas-permeable membrane module from an acid solution tank, then returning the acid absorption solution to the acid solution tank, and keeping a circulating state;
step 4): driving, under action of ammonia mass transfer in the tubular gas-permeable membrane module, ammonia nitrogen in the wastewater to enter the acid absorption solution in a molecular state of NH₃, and starting discharge of the wastewater when the ammonia nitrogen in the wastewater is reduced to a discharge standard;
step 5): gradually increasing a concentration of an ammonium salt in the acid absorption solution along with prolonging of circulating operation time until an ammonium salt solution in the acid solution tank reaches a saturated state; and
step 6): evaporating and crystallizing the saturated ammonium salt solution to obtain solid ammonium salt, and recovering an ammonia nitrogen resource.

Preferably, a concentration of the ammonia nitrogen wastewater in step 1) is 10 mg/L-5000 mg/L, a pH value of the ammonia nitrogen wastewater is adjusted to 10-12, and an adjustment method is to add one or a combination of more of sodium hydroxide, calcium hydroxide, and calcium oxide.

Preferably, the temperature of the ammonia nitrogen wastewater in step 2) is adjusted to 5° C.-40° C., and the membrane surface flow rate is set as 1 m/min-100 m/min.

Preferably, a concentration of the acid absorption solution in step 3) is 1 wt %-20 wt %, and the acid absorption solution is one or a combination of more of sulfuric acid, nitric acid, hydrochloric acid, and phosphoric acid.

Compared with the prior art, the present disclosure has the following beneficial effects:
(1) The tubular gas-permeable membrane of the present disclosure has a double-layer structure of a porous support layer and a microporous hydrophobic layer, and has desirable chemical resistance. By adopting the ultrasonic-assisted heating curing bonding process, the overlapped area has a high strength and desirable corrosion resistance and is unlikely to fall off. Thus, sealing performance is greatly improved, a service life is greatly prolonged, and an effect of long-term stable operation is achieved.
(2) The tubular gas-permeable membrane module of the present disclosure has a wide flow path, and is unlikely to be blocked. In addition, wastewater pretreatment is simple, and the wastewater having a high content of suspended solids is allowed to enter the membrane module. The closed columnar membrane structure is adopted, such that secondary pollution can be avoided.
(3) The wastewater treatment of an ammonia nitrogen removal process of the present disclosure adopts cross-flow filtration, a high cross-flow velocity can reduce an adhesion speed of pollutants such as organic matter to a membrane surface, membrane pollution can be reduced, and high ammonia nitrogen removal efficiency can be maintained.
(4) The preparation method for a tubular gas-permeable membrane and the wastewater treatment of an ammonia nitrogen removal process provided by the present disclosure have a wide application range and high ammonia nitrogen removal efficiency. An ammonia nitrogen resource can be recovered while ammonia nitrogen wastewater is treated, and desirable economic benefits and environmental benefits are achieved.

### BRIEF DESCRIPTION OF THE DRAWINGS

FIG. 1 shows a schematic preparation flowchart of a tubular gas-permeable membrane and a module thereof of the present disclosure;

FIGS. 2A-2B show pictures of a tubular gas-permeable membrane module prepared by the present disclosure, in which FIG. 2A is a top view and FIG. 2B is a side view; and

FIG. 3 shows a process flowchart of ammonia nitrogen removal treatment using a tubular gas-permeable membrane prepared by the present disclosure.

### DETAILED DESCRIPTION OF THE EMBODIMENTS

In order to make the present disclosure clearer and more comprehensible, detailed description will be made below with reference to preferred embodiments and in conjunction with accompanying drawings.

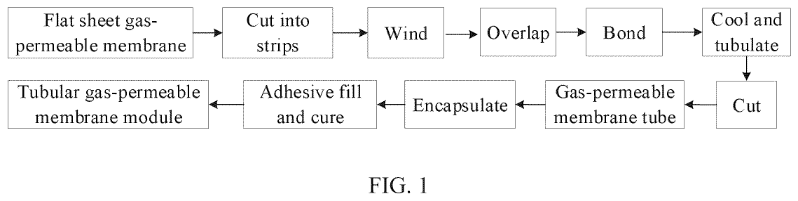

The present disclosure provides a tubular gas-permeable membrane for wastewater treatment and a preparation method for a membrane module with a preparation process is shown in FIG. 1. The preparation method includes:

Step 1: a flat sheet gas-permeable membrane is cut into a strip shape. The flat sheet gas-permeable membrane has a quantitative range of 50 g/m²-100 g/m², a thickness is set as 100 μm-250 μm, and an air permeability is set as 0.05 m/s-1.5 m/s. An average pore diameter is set as 0.05 μm-4.5 μm, a contact angle is set as 110°-140°, and the strip-shaped flat sheet gas-permeable membrane has a width of 10 mm-20 mm.

Step 2: the strip-shaped flat sheet gas-permeable membrane is wound. A winding diameter is 5 mm-10 mm, and a width controlled range of an overlapped area of an upper layer and a lower layer of the gas-permeable membrane is 0.5 mm-2 mm during the winding.

Step 3: a chemical adhesive is uniformly applied to the overlapped area of opposite sides of the membrane by adopting an ultrasonic-assisted heating curing bonding process during the winding, and then ultrasonic-assisted heating curing is performed. The chemical adhesive is an aqueous dispersion liquid of acrylonitrile multipolymer, a frequency of ultrasound is 15 kHz-40 kHz, and a temperature of the heating curing is 150° C.-250° C.

Step 4: a tube-shaped tubular gas-permeable membrane formed through bonding during tubulation is rapidly cooled, a temperature of a membrane tube is reduced to a room temperature, and a cooled temperature is controlled within 5° C.-20° C. An inner diameter range of the tubular gas-permeable membrane is 5 mm-10 mm.

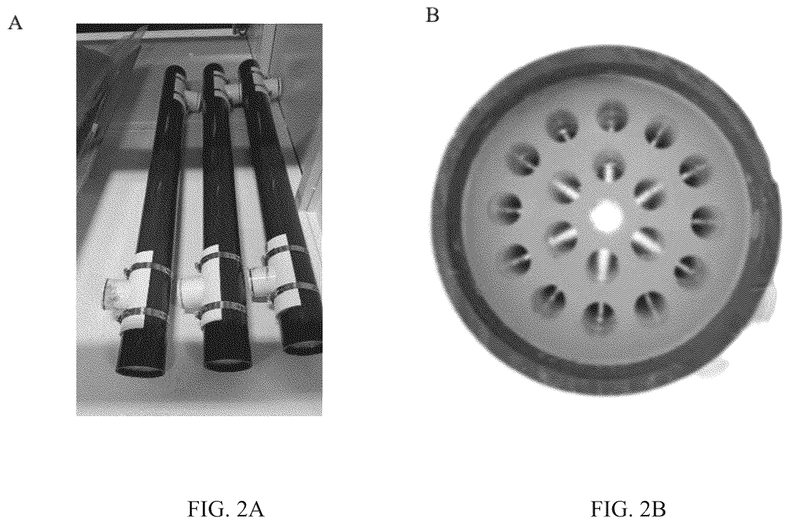

Step 5: an encapsulation tube is filled with cut tubular gas-permeable membranes, adhesive filling, curing, etc. are performed, and a tubular gas-permeable membrane module is formed. The tubular gas-permeable membrane module is shown in FIGS. 2A-2B.

In the preparation method of the present disclosure, after repeated attempts, it is found that a strength of the overlapped area of the membrane can be significantly improved by using acrylonitrile multipolymer as the adhesive for bonding in the ultrasonic-assisted heating curing bonding process, and the membrane is unlikely to fall off, and can operate stably in an acid or alkali medium for a long time. Desirable resistance to acid and alkali and resistance to oxidation resistance are achieved, and service lives of the membrane and the membrane module thereof are obviously prolonged.

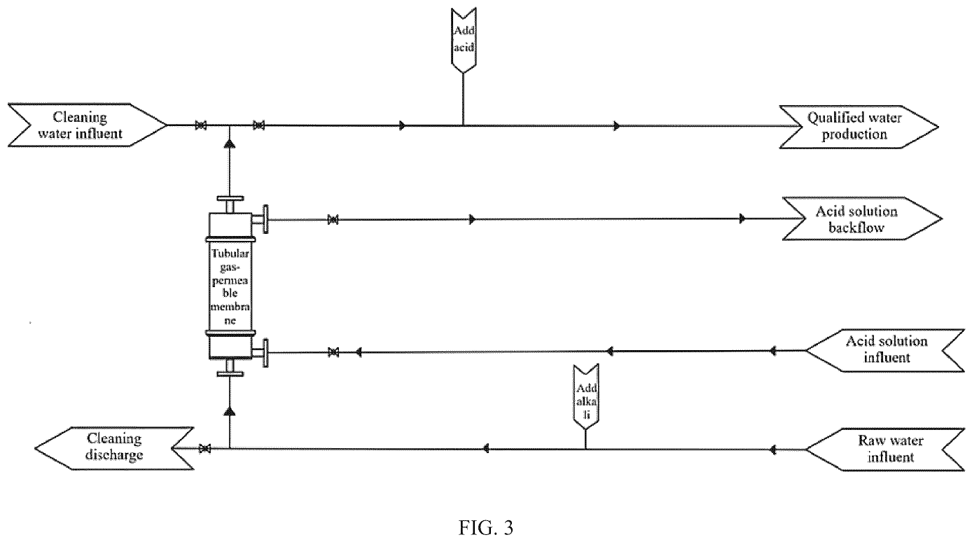

The present disclosure further provides a method using the tubular gas-permeable membrane module described above for wastewater ammonia nitrogen removal treatment with a process flow shown in FIG. 3. The method includes:

Step 1: a pH of ammonia nitrogen wastewater is adjusted to 10-12, a temperature is adjusted to 5° C.-40° C., the ammonia nitrogen wastewater is pumped into a tube side of the tubular gas-permeable membrane module, and a membrane surface flow rate is 1 m/min-100 m/min. An acid absorption solution is pumped into a shell side of the tubular gas-permeable membrane module, and a concentration of the acid absorption solution is 1 wt %-20 wt %. Then the acid absorption solution is returned to the acid solution tank to keep a circulating state.

Step 2: ammonia nitrogen in the wastewater is driven, under action of ammonia mass transfer in the tubular gas-permeable membrane, to enter the acid absorption solution in a molecular state of NH₃, and discharge of the wastewater is started when the ammonia nitrogen in the wastewater is gradually reduced to a discharge standard.

Step 3: a concentration of an ammonium salt in the acid absorption solution is gradually increased along with prolonging of circulating operation time until an ammonium salt solution in the acid solution tank reaches a saturated state. The saturated ammonium salt solution is evaporated and crystallized to obtain solid ammonium salt, and an ammonia nitrogen resource is recovered.

In Embodiment 1 to Embodiment 5, the aqueous dispersion liquid of acrylonitrile multipolymer, the chemical adhesive, is an LA133 brand product produced by Chengdu Indigo Power Technology Co., Ltd. The flat sheet gas-permeable membrane is cited from the invention patent “Flat Sheet gas-permeable membrane for Wastewater Treatment and Preparation Method Therefor” (ZL202010862209.4) applied for by the applicant early and authorized, which is incorporated herein in its entirety by reference. The flat sheet gas-permeable membrane includes a non-woven fabric substrate layer and a gas permeable layer. The non-woven fabric substrate layer and the gas permeable layer are bonded into a whole. The non-woven fabric substrate includes polypropylene fiber, cellulose fiber, and carbon fiber, and the polypropylene fiber accounts for 60 wt %-90 wt %, the cellulose fiber accounts for 5 wt %-30 wt %, and the carbon fiber accounts for 5 wt %-15 wt %. The gas permeable layer is an expanded polytetrafluoroethylene film. The polypropylene fiber includes one or two of monocomponent polypropylene fiber and bicomponent polyethylene/polypropylene fiber. A melting point of the monocomponent polypropylene fiber is 150° C.-190° C. The bicomponent polyethylene/polypropylene fiber is sheath-core fiber, a melting point of a skin layer is 90° C.-150° C., and a melting point of a fiber body is 150° C.-190° C. A beating degree of the cellulose fiber is 30° SR-60° SR. The cellulose fiber is bamboo pulp fiber and wood pulp fiber. Temperature resistance of the carbon fiber is higher than 300° C. The expanded polytetrafluoroethylene film has an air permeability of 0.1 m/s-5 m/s, an average pore diameter of 0.1 μm-5 μm, a porosity of 50%-80%, and a contact angle of 110°-140°. The preparation method for the flat sheet gas-permeable membrane includes:

Step 1: a mixed fiber pulp composed of polypropylene fiber, cellulose fiber, and carbon fiber is made by a paper-making machine by using a wet papermaking process, to form a non-woven fabric substrate. In making process parameters of the non-woven fabric substrate, a sizing concentration of the paper-making machine is set as 0.01 wt %-0.5 wt %, a drying temperature of the non-woven fabric substrate is set as 90° C.-120° C., and a soft calendering temperature is set as 100° C.-130° C.

Step 2: the nonwoven fabric substrate and an expanded polytetrafluoroethylene film are stacked up and down in advance.

Step 3: putting is performed into a hot press for high-temperature hot pressing treatment. A hot pressing temperature is related to the melting point and a hot pressing pressure of the selected polypropylene fiber. During high-temperature hot pressing treatment, a hot-pressing compounding temperature of the gas-permeable membrane is 140° C.-170° C., and a pressure range is set as 0.5 MPa-2.5 MPa. A particular gradient relationship exists between the temperature required for the hot-pressing compounding process of the flat sheet gas-permeable membrane and the temperatures required for the drying and soft calendering process of the non-woven fabric substrate. A drying temperature of 90° C.-120° C. of the non-woven fabric substrate is less than the soft calendering temperature of 100° C.-130° C. is less than the hot-pressing compounding temperature of 140° C.-170° C. of the gas-permeable membrane.

Step 4: after the hot-pressing compounding, cooling is performed to form the flat sheet gas-permeable membrane. The flat sheet gas-permeable membrane has a quantity of 50 g/m²-100 g/m², a thickness of 100 μm-250 μm, an air permeability of 0.05 m/s-1.5 m/s, an average pore diameter of 0.05 μm-4.5 μm, and a contact angle of 110°-140°.

### Embodiment 1

A tubular gas-permeable membrane and a module thereof were provided. A preparation process of the module was as follows: a flat sheet gas-permeable membrane with a quantity of 50 g/m², a thickness of 100 μm, an air permeability of 0.05 m/s, an average pore diameter of 0.05 μm, and a contact angle of 110° was cut into a strip shape of 10 mm. The flat sheet gas-permeable membrane was wound with a winding diameter of 5 mm. During winding, two opposite sides were overlapped up and down during the winding, and an overlapped width of an upper layer and a lower layer was 0.5 mm. A chemical adhesive of an aqueous dispersion liquid of acrylonitrile multipolymer was uniformly applied to an overlapped area, and then ultrasonic-assisted heating curing was performed with an ultrasonic frequency of 15 kHz and a curing temperature of 150° C. Then cooling was performed at 20° C., and a gas-permeable membrane tube with an inner diameter of 5 mm was obtained. The membrane tube was cut, then a tube was filled with cut membrane tubes, and adhesive filling and curing were performed to obtain the tubular gas-permeable membrane module with φ5 mm*1.2 m.

A process of wastewater ammonia nitrogen removal treatment using the tubular gas-permeable membrane module described above was as follows: landfill leachate with an ammonia nitrogen concentration of 10 mg/L was denitrified, sodium hydroxide was added to adjust a pH of influent to 10, and a temperature was adjusted to 5° C. The landfill leachate was pumped into a tube side of the tubular gas-permeable membrane module at a membrane surface flow rate of 1 m/min, and 1 wt % sulfuric acid solution was pumped into a shell side of the tubular gas-permeable membrane module, and then returned to an acid solution tank, to keep a circulating state. Ammonia nitrogen in wastewater gradually decreased and was absorbed by the sulfuric acid solution continuously, and a concentration of ammonium sulfate in the acid solution tank gradually increased. Finally, ammonia nitrogen removal efficiency of the wastewater was 82.9%. The ammonium sulfate in the acid solution tank was evaporated and crystallized to obtain solid ammonium sulfate with a N content of 20.5 wt %.

### Embodiment 2

A tubular gas-permeable membrane and a module thereof were provided. A preparation process of the module was as follows: a flat sheet gas-permeable membrane with a quantity of 100 g/m², a thickness of 250 μm, an air permeability of 1.5 m/s, an average pore diameter of 4.5 μm, and a contact angle of 140° was cut into a strip shape of 20 mm. The flat sheet gas-permeable membrane was wound with a winding diameter of 10 mm. During winding, two opposite sides were overlapped up and down during the winding, and an overlapped width of an upper layer and a lower layer was 2 mm. A chemical adhesive of an aqueous dispersion liquid of acrylonitrile multipolymer was uniformly applied to an overlapped area, and then ultrasonic-assisted heating curing was performed with an ultrasonic frequency of 20 kHz and a curing temperature of 250° C. Then cooling was performed at 20° C., and a gas-permeable membrane tube with an inner diameter of 10 mm was obtained. The membrane tube was cut, then a tube was filled with cut membrane tubes, and adhesive filling and curing were performed to obtain the tubular gas-permeable membrane module with φ10 mm*1.2 m.

A process of wastewater ammonia nitrogen removal treatment using the tubular gas-permeable membrane module described above was as follows: kitchen biogas slurry with an ammonia nitrogen concentration of 5000 mg/L was denitrified, calcium hydroxide was added to adjust a pH of influent to 12, and a temperature was adjusted to 40° C. The kitchen biogas slurry was pumped into a tube side of the tubular gas-permeable membrane module at a membrane surface flow rate of 100 m/min, and 20 wt % nitric acid solution was pumped into a shell side of the tubular gas-permeable membrane module, and then returned to an acid solution tank, to keep a circulating state. Ammonia nitrogen in wastewater gradually decreased and was absorbed by the nitric acid solution continuously, and a concentration of ammonium nitrate in the acid solution tank gradually increased. Finally, ammonia nitrogen removal efficiency of the wastewater was 88.3%. The ammonium nitrate in the acid solution tank was evaporated and crystallized to obtain solid ammonium nitrate with a N content of 32.4 wt %.

### Embodiment 3

A tubular gas-permeable membrane and a module thereof were provided. A preparation process of the module was as follows: a flat sheet gas-permeable membrane with a quantity of 80 g/m², a thickness of 140 μm, an air permeability of 0.08 m/s, an average pore diameter of 0.3 μm, and a contact angle of 1200 was cut into a strip shape of 12.5 mm. The flat sheet gas-permeable membrane was wound with a winding diameter of 7 mm. During winding, two opposite sides were overlapped up and down during the winding, and an overlapped width of an upper layer and a lower layer was 0.8 mm. A chemical adhesive of an aqueous dispersion liquid of acrylonitrile multipolymer was uniformly applied to an overlapped area, and then ultrasonic-assisted heating curing was performed with an ultrasonic frequency of 25 kHz and a curing temperature of 170° C. Then cooling was performed at 10° C., and a gas-permeable membrane tube with an inner diameter of 7 mm was obtained. The membrane tube was cut, then a tube was filled with cut membrane tubes, and adhesive filling and curing were performed to obtain the tubular gas-permeable membrane module with φ7 mm*1.2 m.

A process of wastewater ammonia nitrogen removal treatment using the tubular gas-permeable membrane module described above was as follows: metallurgical wastewater with an ammonia nitrogen concentration of 1000 mg/L was denitrified, calcium oxide was added to adjust a pH of influent to 10.7, and a temperature was adjusted to 20° C. The metallurgical wastewater was pumped into a tube side of the tubular gas-permeable membrane module at a membrane surface flow rate of 30 m/min, and 5 wt % phosphoric acid solution was pumped into a shell side of the tubular gas-permeable membrane module, and then returned to an acid solution tank, to keep a circulating state. Ammonia nitrogen in wastewater gradually decreased and was absorbed by the phosphoric acid solution continuously, and a concentration of ammonium phosphate in the acid solution tank gradually increased. Finally, ammonia nitrogen removal efficiency of the wastewater was 87.1%. The ammonium phosphate in the acid solution tank was evaporated and crystallized to obtain solid ammonium phosphate with a N content of 25.8 wt %.

### Embodiment 4

A tubular gas-permeable membrane and a module thereof were provided. A preparation process of the module was as follows: a flat sheet gas-permeable membrane with a quantity of 85 g/m², a thickness of 200 μm, an air permeability of 1.0 m/s, an average pore diameter of 2.5 μm, and a contact angle of 125° was cut into a strip shape of 16.5 mm. The flat sheet gas-permeable membrane was wound with a winding diameter of 8 mm. During winding, two opposite sides were overlapped up and down during the winding, and an overlapped width of an upper layer and a lower layer was 1.2 mm. A chemical adhesive of an aqueous dispersion liquid of acrylonitrile multipolymer was uniformly applied to an overlapped area, and then ultrasonic-assisted heating curing was performed with an ultrasonic frequency of 30 kHz and a curing temperature of 200° C. Then cooling was performed at 15° C., and a gas-permeable membrane tube with an inner diameter of 8 mm was obtained. The membrane tube was cut, then a tube was filled with cut membrane tubes, and adhesive filling and curing were performed to obtain the tubular gas-permeable membrane module with φ8 mm*1.2 m.

A process of wastewater ammonia nitrogen removal treatment using the tubular gas-permeable membrane module described above was as follows: photovoltaic wastewater with an ammonia nitrogen concentration of 2800 mg/L was denitrified, sodium hydroxide was added to adjust a pH of influent to 11, and a temperature was adjusted to 30° C. The photovoltaic wastewater was pumped into a tube side of the tubular gas-permeable membrane module at a membrane surface flow rate of 70 m/min, and 10 wt % hydrochloric acid solution was pumped into a shell side of the tubular gas-permeable membrane module, and then returned to an acid solution tank, to keep a circulating state. Ammonia nitrogen in wastewater gradually decreased and was absorbed by the hydrochloric acid solution continuously, and a concentration of ammonium chloride in the acid solution tank gradually increased. Finally, ammonia nitrogen removal efficiency of the wastewater was 85.4%. The ammonium chloride in the acid solution tank was evaporated and crystallized to obtain solid ammonium chloride with a N content of 21.8 wt %.

### Embodiment 5

A tubular gas-permeable membrane and a module thereof were provided. A preparation process of the module was as follows: a flat sheet gas-permeable membrane with a quantity of 90 g/m², a thickness of 200 μm, an air permeability of 1.2 m/s, an average pore diameter of 3.2 μm, and a contact angle of 128° was cut into a strip shape of 18 mm. The flat sheet gas-permeable membrane was wound with a winding diameter of 8 mm. During winding, two opposite sides were overlapped up and down during the winding, and an overlapped width of an upper layer and a lower layer was 1.5 mm. A chemical adhesive of an aqueous dispersion liquid of acrylonitrile multipolymer was uniformly applied to an overlapped area, and then ultrasonic-assisted heating curing was performed with an ultrasonic frequency of 40 kHz and a curing temperature of 220° C. Then cooling was performed at 15° C., and a gas-permeable membrane tube with an inner diameter of 8 mm was obtained. The membrane tube was cut, then a tube was filled with cut membrane tubes, and adhesive filling and curing were performed to obtain the tubular gas-permeable membrane module with φ8 mm*1.2 m.

A process of wastewater ammonia nitrogen removal treatment using the tubular gas-permeable membrane module described above was as follows: landfill leachate with an ammonia nitrogen concentration of 3500 mg/L was denitrified, sodium hydroxide was added to adjust a pH of influent to 11, and a temperature was adjusted to 35° C. The landfill leachate was pumped into a tube side of the tubular gas-permeable membrane module at a membrane surface flow rate of 85 m/min, and 17.5 wt % sulfuric acid solution was pumped into a shell side of the tubular gas-permeable membrane module, and then returned to an acid solution tank, to keep a circulating state. Ammonia nitrogen in wastewater gradually decreased and was absorbed by the sulfuric acid solution continuously, and a concentration of ammonium sulfate in the acid solution tank gradually increased. Finally, ammonia nitrogen removal efficiency of the wastewater was 90.3%. The ammonium sulfate in the acid solution tank was evaporated and crystallized to obtain solid ammonium sulfate with a N content of 20.8 wt %.

The embodiments described above are merely preferred embodiments of the present disclosure, rather than limitation to any form or substantial limitation to the present disclosure. It should be noted that for those of ordinary skill in the art, several improvements and supplements can be made on the premise without deviating from the present disclosure, and these improvements and supplements should be considered to fall within the protection scope of the present disclosure.

What is claimed is:

1. A preparation method for a tubular gas-permeable membrane, comprising: cutting a flat sheet gas-permeable membrane into a strip shape to obtain a strip-shaped flat sheet gas-permeable membrane, and then sequentially winding, overlapping, bonding, tubulating, and cutting the strip-shaped flat sheet gas-permeable membrane to form a tube-shaped tubular gas-permeable membrane, wherein
the flat sheet gas-permeable membrane comprises a non-woven fabric substrate layer and a gas permeable layer, the non-woven fabric substrate layer and the gas permeable layer are bonded into a whole, the non-woven fabric substrate layer comprises 60 wt %-90 wt % polypropylene fiber, 5 wt %-30 wt % cellulose fiber, and 5 wt %-15 wt % carbon fiber, and the gas permeable layer is an expanded polytetrafluoroethylene film.

2. The preparation method according to claim 1, wherein the flat sheet gas-permeable membrane has a quantitative range of 50 g/m²-100 g/m², a thickness of 100 μm-250 μm, an air permeability of 0.05 m/s-1.5 m/s, an average pore diameter of 0.05 μm-4.5 μm, and a contact angle of 110°-140°.

3. The preparation method according to claim 1, wherein the strip-shaped flat sheet gas-permeable membrane has a width of 10 mm-20 mm.

4. The preparation method according to claim 1, wherein a winding diameter of the strip-shaped flat sheet gas-permeable membrane is 5 mm-10 mm, opposite sides of the strip-shaped flat sheet gas-permeable membrane are overlapped during the winding, and a width of an overlapped area is set as 0.5 mm-2 mm.

5. The preparation method according to claim 1, wherein the bonding adopts an ultrasonic-assisted heating curing bonding process, and comprises: uniformly applying a chemical adhesive to an overlapped area of opposite sides of the strip-shaped flat sheet gas-permeable membrane during the winding, and then performing ultrasonic-assisted heating curing, wherein the chemical adhesive is an aqueous dispersion liquid of acrylonitrile multipolymer, a frequency of ultrasound during the ultrasonic-assisted heating curing is 15 kHz-40 kHz, and a temperature of the ultrasonic-assisted heating curing is 150° C.-250° C.

6. The preparation method according to claim 1, wherein the tubulating comprises: cooling a tube-shaped membrane formed through the bonding, a temperature of the cooling is 5° C.-20° C., and an inner diameter of the tube-shaped membrane is 5 mm-10 mm.

7. A tubular gas-permeable membrane prepared by the preparation method according to claim 1.

8. A method of using the tubular gas-permeable membrane according to claim 7, comprising: using the tubular gas-permeable membrane for preparing a tubular gas-permeable membrane module or in a wastewater ammonia nitrogen removal treatment.

9. A tubular gas-permeable membrane module, comprising the tubular gas-permeable membrane according to claim 7.

10. The tubular gas-permeable membrane module according to claim 9, wherein a preparation method of the tubular gas-permeable membrane module comprises: cutting the tubular gas-permeable membrane according to a predetermined length and size and a required filling number to obtain cut membranes, then filling an encapsulation tube with the cut membranes sequentially, performing adhesive filling and curing, and making the tubular gas-permeable membrane module.

11. A method for a wastewater ammonia nitrogen removal treatment, comprising using the tubular gas-permeable membrane module according to claim 9.

12. A method adopting the tubular gas-permeable membrane module according to claim 9 for a wastewater ammonia nitrogen removal treatment, comprising:
step 1): adjusting a pH value of ammonia nitrogen wastewater to alkalinity;
step 2): adjusting a temperature of the ammonia nitrogen wastewater, then pumping the ammonia nitrogen wastewater into a tube side of the tubular gas-permeable membrane module, and adjusting a membrane surface flow rate;
step 3): pumping an acid absorption solution into a shell side of the tubular gas-permeable membrane module from an acid solution tank, then returning the acid absorption solution to the acid solution tank, and keeping a circulating state;
step 4): driving, under an action of ammonia mass transfer in the tubular gas-permeable membrane module, ammonia nitrogen in the ammonia nitrogen wastewater to enter the acid absorption solution in a molecular state of NH₃, and starting discharge of the ammonia nitrogen wastewater when the ammonia nitrogen in the ammonia nitrogen wastewater is reduced to a discharge standard;
step 5): gradually increasing a concentration of an ammonium salt in the acid absorption solution along with prolonging of circulating operation time until an ammonium salt solution in the acid solution tank reaches a saturated state; and
step 6): evaporating and crystallizing a saturated ammonium salt solution to obtain a solid ammonium salt, and recovering an ammonia nitrogen resource.

13. The method according to claim 12, wherein a concentration of the ammonia nitrogen wastewater in the step 1) is 10 mg/L-5000 mg/L, the pH value of the ammonia nitrogen wastewater is adjusted to 10-12, and an adjustment method of the pH value of the ammonia nitrogen wastewater is to add one or a combination of more of sodium hydroxide, calcium hydroxide, and calcium oxide.

14. The method according to claim 12, wherein the temperature of the ammonia nitrogen wastewater in the step 2) is adjusted to 5° C.-40° C., and the membrane surface flow rate is set as 1 m/min-100 m/min.

15. The method according to claim 12, wherein a concentration of the acid absorption solution in the step 3) is 1 wt %-20 wt %, and the acid absorption solution is one or a combination of more of sulfuric acid, nitric acid, hydrochloric acid, and phosphoric acid.

16. The tubular gas-permeable membrane according to claim 7, wherein in the preparation method for the tubular gas-permeable membrane, the flat sheet gas-permeable membrane has a quantitative range of 50 g/m²-100 g/m², a thickness of 100 μm-250 μm, an air permeability of 0.05 m/s-1.5 m/s, an average pore diameter of 0.05 μm-4.5 μm, and a contact angle of 110°-140°.

17. The tubular gas-permeable membrane according to claim 7, wherein in the preparation method for the tubular gas-permeable membrane, the strip-shaped flat sheet gas-permeable membrane has a width of 10 mm-20 mm.

18. The tubular gas-permeable membrane according to claim 7, wherein in the preparation method for the tubular gas-permeable membrane, a winding diameter of the strip-shaped flat sheet gas-permeable membrane is 5 mm-10 mm, opposite sides of the strip-shaped flat sheet gas-permeable membrane are overlapped during the winding, and a width of an overlapped area is set as 0.5 mm-2 mm.

19. The tubular gas-permeable membrane according to claim 7, wherein in the preparation method for the tubular gas-permeable membrane, the bonding adopts an ultrasonic-assisted heating curing bonding process, and comprises: uniformly applying a chemical adhesive to an overlapped area of opposite sides of the strip-shaped flat sheet gas-permeable membrane during the winding, and then performing ultrasonic-assisted heating curing, wherein the chemical adhesive is an aqueous dispersion liquid of acrylonitrile multipolymer, a frequency of ultrasound during the ultrasonic-assisted heating curing is 15 kHz-40 kHz, and a temperature of the ultrasonic-assisted heating curing is 150° C.-250° C.

20. The tubular gas-permeable membrane according to claim 7, wherein in the preparation method for the tubular gas-permeable membrane, the tubulating comprises: cooling a tube-shaped membrane formed through the bonding, a temperature of the cooling is 5° C.-20° C., and an inner diameter of the tube-shaped membrane is 5 mm-10 mm.
